(19) United States
(12) Patent Application Publication
(10) Pub. No.: US 2015/0284659 A1
(43) Pub. Date: Oct. 8, 2015

(54) METHOD AND COMPOSITION FOR INCREASING RECOVERY OF OIL FROM FERMENTATION PROCESSES

(71) Applicant: U.S. Water Services, Inc., St. Michael, MN (US)

(72) Inventor: Paul R. Young, Wheaton, IL (US)

(21) Appl. No.: 14/680,507

(22) Filed: Apr. 7, 2015

Related U.S. Application Data
(60) Provisional application No. 61/976,208, filed on Apr. 7, 2014.

(51) Int. Cl. C11B 3/00

(52) U.S. Cl. CPC C11B 3/006

(57) ABSTRACT

The present invention relates to a method for increasing recovery of oil, such as vegetable oil, from a fermentation process.

### CROSS-REFERENCE TO RELATED APPLICATION

This application claims benefit of U.S. Provisional Application No. 61/976,208, filed Apr. 7, 2014, which application is incorporated herein by reference.

### FIELD OF THE INVENTION

The present invention relates to a method for increasing recovery of oil, such as vegetable oil, from a fermentation fluid.

### BACKGROUND OF THE INVENTION

Fermentation is a common method of converting a substrate material, such as sugar or starch, into another, such as lactic acid, vinegar, or ethanol. The substrate for fermentation is often derived from grains such as corn, wheat, sorghum, or the like. It can be advantageous to process grain without fractionating to separate by-products, or such separation, when practiced, may be incomplete. The feedstock starting material is therefore often a grain product which naturally contains compounds other than the substrate of the fermentation. One such compound is vegetable oil, which has significant value if it can be separated from the fermentation process.

Perhaps the largest use of fermentation is the production of alcohol. The fermentation of starch or sugar to alcohol may produce beverage ethanol, fuel ethanol, chemical ethanol, or butanol. Only the starch is converted to ethanol, but oils, fiber, proteins and many other compounds are also present. These compounds are not substantially changed during the process, but are not desired in the end product. These compounds, together with the cells of the yeast or bacteria performing the fermentation, are typically removed from the process fluids by distillation, filtration, settling, or centrifugation. The extraneous compounds are thus concentrated in a by-product stream.

Recovering oil, such as vegetable oil, from a fermentation fluid is desirable. There remains a need for improved methods for recovering oil from a fermentation fluid.

### SUMMARY OF THE INVENTION

The present invention relates to a method for increasing recovery of oil, such as vegetable oil, from a fermentation fluid, such as a fermentation by-product stream.

In an embodiment, the present invention relates to a method for recovering oil from a fermentation process that includes adding an additive to a process stream wherein the additive includes ethoxylated glyceryl monostearate, ethoxylated castor oil, ethoxylated hydrogenated castor oil, polyglyceryl monooleate, a sucrose ester of a fatty acid, or a mixture thereof.

In an embodiment, the present invention relates to a method for recovering oil from a fermentation process that includes adding an additive to a process stream wherein the additive includes a functionalized multihydroxyl moiety comprising a hydrophobic portion. In this embodiment, the functionalized multihydroxyl moiety can be derived from glycerol, polyglycerol, glucose, sucrose, citric acid, lactic acid, tartaric acid, or an amino acid. In this embodiment, the hydrophobic portion can include one or two alkyl groups of 6 to 24 carbons each.

In an embodiment, the present invention relates to a method for recovering oil from a fermentation process that includes adding an additive to a process stream wherein the additive includes an alkylated polyglycerol, an alkoxylated castor oil, an alkoxylated hydrogenated castor oil, an alkoxylated monoglyceride, an alkoxylated mono/di-glyceride, an oligosaccharide ester, or a mixture thereof.

In an embodiment, the present invention relates to a method for recovering oil from a fermentation process that includes adding an additive to a process stream wherein the additive includes ethoxylated glyceryl monostearate, castor oil ethoxylate, or a mixture thereof.

In an embodiment, the present invention relates to a method for recovering oil from a fermentation process that includes adding an additive to a process stream wherein the additive comprises a functionalized multihydroxyl moiety comprising a hydrophilic portion and a hydrophobic portion. In this embodiment, the hydrophilic portion can include at least two terminal hydroxyl groups; and the hydrophobic portion can include one or two alkyl groups of 6 to 24 carbons each. In this embodiment, the functionalized multihydroxyl moiety is not derived from sorbitol, sorbitan, or an isosorbide.

### DETAILED DESCRIPTION OF THE INVENTION

### Definitions

A fermentation fluid is a fluid containing water mixed with grain products or by-products that has been or is intended to be fermented. The grain products or by-products can contain oil. A fermentation fluid may be the entire volume of processed material, or a portion thereof, or a by-product, or a waste product.

“Fermentation” refers to a process of converting a substrate material, such as sugar or starch, into another, such as lactic acid, vinegar, or ethanol, by the action of microorganisms and/or enzymes. For example, in fermentation to produce fuel ethanol, polysaccharides such as starch or cellulose are converted enzymatically to simple sugars, and the sugars are converted into alcohol by the action of yeast. The term fermentation is often used as a label for the entire process of many steps to prepare the substrate and to separate the products, not only the fermentation step itself. “Fermentation” includes a process by which the sugars in the slurry or mash from liquefaction/saccharification are converted into alcohol by the action of yeast in the fermentation tanks or fermentors.

As used herein, the term “mash” refers to a mixture or slurry of milled grain, process water and an enzyme such as alpha amylase, after the mixture has been subjected to a high temperature “cook” process. The addition of enzymes results in liquefaction/saccharification of the slurry. Mash is cooled and introduced into fermentation tank during ethanol processing. The feedstock for fermentation can be corn starch or ground corn or a corn/sorghum blend that is mixed with water and heated to form a slurry or mash.

The mash is allowed to ferment in a fermentation tank for 30-60 hours, resulting in a mixture that contains about 15% ethanol as well as the solids from the grain and added yeast, i.e. the “fermentation slurry” or “beer.” Once fermentation is complete, the beer is moved into a holding tank called a beer well. Ethanol can be recovered by distillation or membrane separation. Butanol is typically recovered by membrane separation.

The term “whole stillage” refers to the fluid remaining after ethanol is removed from beer or beer mash using a distillation column. The term is used interchangeably with the term “thick stillage.” Whole stillage is typically 11% to 14% solids and contains all of the other non-starch components of the grains that pass through the process (germ, protein, gluten, oil, hull & fiber etc.).

It can be advantageous to remove much of the heavier suspended solids from whole stillage via centrifugation. The high-solids portion is commonly called “wet cake” or “wet grains” and may be from 30-50% solids. “Thin stillage” refers to the liquid removed from the whole stillage. Thin stillage is about 5% dry matter and about 95% water. Thin stillage can be reintroduced into the production processes. Thin stillage that is recycled to the beginning of the dry-grind process is known as “backset” and is used to conserve water, energy, and nutrients used in processing. Alternatively, thin stillage may be concentrated in evaporators to form “syrup” commonly containing 25-35% solids. The terms “thin stillage,” “concentrated thin stillage,” and “syrup” are often used interchangeably, even though they technically reflect increasing degrees of concentration.

As used herein, a terminal hydroxyl group is an OH moiety bonded to an aliphatic carbon atom, where the carbon atom may be bonded to one, two, or three other carbon atoms. This definition is not meant to exclude secondary or tertiary alcohols, but rather to exclude those hydroxyl groups from precursor molecules which have been reacted to form ethers, esters, amides, etc., and are no longer truly hydroxyl groups, as well as to exclude carboxylic acids. Terminal hydroxyl groups are found at the free end of ethylene oxide and propylene oxide chains, as well as on glycerol and saccharides, and on the fatty acid groups of castor oil.

As used herein, a multihydroxyl moiety is a molecule which has at least two terminal hydroxyl groups, as in glycerol, monoacylated glycerol, polyglycerols, and saccharides. While glycols and glycerol would be considered multihydroxyl moieties, acylated glycols would not, because the hydroxyls have been reacted to form an ester.

Alkylation and acylation refer to the addition of a group containing primarily carbon and hydrogen to a molecule, with alkylation being more general, and acylation referring more specifically to addition through a carboxylic acid. These terms describe the final molecules, and are not intended to indicate any specific chemical reactions used to create the final molecules, so that a monoglyceride would be described as an acylated or alkylated glycerol, whether it was formed by adding a fatty acid to glycerol or by removing two fatty acids from a triglyceride.

Surfactants are molecules with distinct hydrophilic portions and hydrophobic portions, and are well known. There are many ways of classifying surfactants according to general properties and uses, rather than specific structures. One of the most common is Hydrophilic Lipophilic Balance or HLB. While there are several ways of estimating HLB, it is sufficient here to state that molecules with hydrophilic portions much larger than their hydrophobic portions have high HLB (>10), and those with hydrophilic portions much smaller than their hydrophobic portions have low HLB (<10). Various ranges of HLB values are known to correlate with various activities, such as emulsification. The HLB values of various surfactants have been described. Another useful property of surfactants is the cloud point. Cloud point is the temperature above which an aqueous solution of a water-soluble surfactant becomes turbid. There is usually a significant change in the dispersant/emulsifier activity of a surfactant as the temperature increases past the cloud point.

It is understood that when describing the chemical nature of natural ingredients and their functionalized derivatives, common names indicate a range of compositions. For example, “oleate” or “stearate” typically contain significant amounts of other fatty acids, and the designation “ethoxylated with 20 moles of EO” refers to a polydisperse distribution of molecules, with an average degree of ethoxylation of approximately 20.

### The Present Method

The present invention relates to a method for recovering oil from a fermentation fluid, such as a fermentation by-product stream from the conversion of corn to ethanol. The present method includes adding an additive to a process stream in a fermentation process. The present method includes adding an additive to a process stream including a fermentation fluid. The additive can increase separation or recovery of oil from stillage. The additive can be or include a functionalized multihydroxyl moiety multihydroxyl moiety derived, for example, from a hydrophobic moiety and glycerol, polyglycerol, glucose, sucrose or other saccharides, citric acid, lactic acid, tartaric acid, or an amino acid; or a mixture of such functionalized multihydroxyl moieties. The functionalized multihydroxyl moiety is not derived from a sorbitol, a sorbitan, or isosorbide. The process stream can include, for example, beer, wet brewer's grains, wet brewer's yeast, wet distillers grains, whole stillage, thin stillage, concentrated thin stillage, syrup, or the like.

In an embodiment, the additive is or includes ethoxylated glyceryl monostearate, ethoxylated castor oil (i.e., castor oil ethoxylate), ethoxylated hydrogenated castor oil, a polyglyceryl monooleate, a sucrose ester of a fatty acid, or a mixture thereof. In an embodiment, the ethoxylated glyceryl monostearate includes about 20 ethoxylate moieties. For example a mole of glyceryl monostearate can be derivatized with 20 moles of ethylene oxide. The ethoxylated glyceryl monostearate can be PEG20 glyceryl stearate. In an embodiment, the castor oil ethoxylate or ethoxylated hydrogenated castor oil includes about 30 to about 60 (e.g., about 40) ethoxylate moieties. For example, one mole of castor oil can be derivatized with 40 moles of ethylene oxide. In an embodiment, the polyglyceryl monooleate includes about 10 condensed glycerol molecules. For example, ten moles of glycerol can be condensed to form one mole of polyglycerol, and this may be further reacted with one mole of oleic acid to form an ester. In an embodiment, the sucrose ester includes sucrose monopalmitate. For example, one mole of sucrose may be reacted with one mole of palmitic acid to form an ester.

In an embodiment, the additive is or includes ethoxylated glyceryl monostearate, ethoxylated castor oil (i.e., castor oil ethoxylate), ethoxylated hydrogenated castor oil, a polyglyceryl monooleate, a sucrose ester of a fatty acid, or a mixture thereof; and the process stream is or includes whole stillage, thin stillage, concentrated thin stillage, syrup, or a plurality thereof.

In an embodiment, the present method includes adding the additive to a concentration of about 30 to about 1000 ppm based on the weight of the process stream. In an embodiment, the present method includes adding the additive to a concentration of about 50 to about 600 ppm based on the weight of the process stream. The amount can be selected as appropriate for a particular process stream or particular facility.

Examples of suitable alkoxylated mono glyceride and mono/di-glyceride include those sold under the trade names Aldosperse MS-20 available from Lonza Corporation and Durfax EOM, available from Loders Croklaan Corporation. Alkoxylated mono- and di-glycerides can be prepared by the removal or replacement of one or more of the fatty acid groups in a triglyceride molecule, and subsequent reaction with ethylene oxide, propylene oxide, ethylene glycol, or propylene glycol.

Examples of suitable alkoxylated castor oil include Stepantex CO-40 (40 EO) available from Stepan Chemical Company, Cirrasol G-1292 (25 EO) from Croda Inc., and Gujchem CO-60 (60 EO) from Gujarat Chemical. Alkoxylated castor oil can be prepared by reaction of castor oil or hydrogenated castor oil with ethylene oxide, propylene oxide, ethylene glycol, or propylene glycol. An example of an alkoxylated castor oil is Stepantex CO-40 available from Stepan Chemical Company.

An example of suitable alkoxylated hydrogenated castor oils include Alkest 400 RH, available from Oxiteno corporation. Alkoxylated hydrogenated castor oil can be prepared by reaction of hydrogenated castor oil with ethylene oxide, propylene oxide, ethylene glycol, or propylene glycol.

In the case of castor oil or hydrogenated castor oil, the same molecule contains a hydrophobic portion and hydroxyl groups suitable for derivatization. Other unsaturated oils may be modified to add hydroxyl groups and such modified oils may be substituted for castor oil.

Examples of suitable sucrose esters include Sisterna PS750 and Sisterna SP70, available from Sisterna B.V. Sucrose esters can be prepared by reacting sucrose with fatty acids to form an ester.

An example of suitable polyglyceryl monooleates includes PolyAldo 10-1-O available from Lonza corporation. These can be prepared by condensing ten glycerol molecules to form a polyglycerol molecule, and further reaction with one oleic acid molecule to form an ester. Other polyglycerol esters can be prepared by the combination of alkyl groups, usually derived from fatty acids, with glycerol which has been polymerized via condensation. Examples are sold under the trade names Polyaldo 10-2-P and Polyaldo 10-1-CC and are available from Lonza corporation. Suitable polyglycerol ester fatty acids include polyglyceryl-10 decaoleate, polyglyceryl-3 stearate, polyglyceryl-6 distearate, polyglyceryl-10 stearate, polyglyceryl-10 dipalmitate, polyglyceryl-10 oleate, and polyglyceryl-10 caprylate/caproate.

### Additional Embodiments of Additives

In an embodiment, the additive is or includes an alkoxylated monoglyceride or alkoxylated mono/di-glyceride with a high proportion of monoglyceride. In an embodiment, the alkoxylated glyceryl monostearate includes about 5 to about 40 (e.g., about 20) alkoxylate moieties, for example ethoxylate or propoxylated moieties. For example, a mole of glyceryl monostearate can be derivatized with about 5 to about 40 (e.g., about 20) moles of alkylene oxide, for example propylene oxide, ethylene oxide, or a mixture thereof. In an embodiment, the alkoxylated monoglyceride or alkoxylated mono/di-glyceride with a high proportion of monoglyceride includes about 12 to about 25 alkoxylate moieties, for example ethoxylate or propoxylated moieties. For example, a mole of glyceryl monostearate can be derivatized with about 12 to about 25 moles of alkylene oxide, for example propylene oxide, ethylene oxide, or a mixture thereof.

In an embodiment, the castor oil alkoxylate includes about 10 to about 60 (e.g., about 40) alkoxylate moieties. For example, one mole of castor oil or hydrogenated castor oil, or mixture thereof can be derivatized with about 10 to about 60 (e.g., about 40) moles of alkylene oxide, for example propylene oxide, ethylene oxide, or a mixture thereof.

In an embodiment, the additive is or includes a polyglycerol ester. In an embodiment, the polyglycerol ester includes a polyglycerol containing 3-20 glycerol units acylated or alkylated with one or two alkyl groups of 6 to 24 carbons.

In an embodiment, the additive includes a low molecular weight saccharide acylated or alkylated with one or two alkyl groups of 6 to 24 carbons. For example, one mole of sucrose can be reacted with one mole of fatty acid to form an ester.

In an embodiment, the additive is or includes a functionalized multihydroxyl moiety including a hydrophobic portion. In this embodiment, the functionalized multihydroxyl moiety can be derived from glycerol, polyglycerol, glucose, sucrose, citric acid, lactic acid, tartaric acid, or an amino acid. These may be modified by reaction with other hydrophilic substituents such as glycerol, glycols, or alkylene oxides by known methods. The hydrophobic portion can include one or two groups of 6 to 24 carbons (e.g., 6 to 24 carbon alkyl groups) each. The hydrophobic portion can include linear, branched, or cyclic groups.

In an embodiment, the additive is or includes a functionalized multihydroxyl moiety derived from a monoglyceride, a mixture of mono and di-glycerides, a polyglycerol, a low molecular weight saccharide, or castor oil. For example, the functionalized multihydroxyl moiety can be derived from ethoxylated monoglyceride, ethoxylated mono/diglyceride, polyglycerol ester, ethoxylated castor oil, or sucrose ester. Such a functionalized multihydroxyl moiety can be or include ethoxylated monoglyceride or ethoxylated mono/diglyceride with one or two alkyl or acyl groups of 6 to 24 carbons each, alkoxylated with from 5 to 40 moles of alkylene oxide (e.g., ethylene oxide or propylene oxide) or alkylene glycol. In an embodiment, the functionalized multihydroxyl moiety has been alkylated or acylated to form a monolaurate, monooleate, monopalmitate or monostearate, and has been alkoxylated with from about 12 to about 25 moles of an alkoxylate wherein the alkoxylate is selected from ethylene oxide, propylene oxide or mixtures thereof.

In an embodiment, the additive is or includes a functionalized multihydroxyl moiety including a hydrophilic portion and a hydrophobic portion. In this embodiment, the hydrophilic portion can include at least two terminal hydroxyl groups. The hydrophobic portion can include one or two alkyl groups of 6 to 24 carbons each. In this embodiment, the functionalized multihydroxyl moiety is not derived from sorbitol, sorbitan, or an isosorbide.

In an embodiment, the additive includes a hydrophilic portion and a hydrophobic portion. The hydrophobic portion can contain alkyl groups with an alkyl chain length of from about 6 to about 24 carbons, for example, from about 8 to about 18 carbons, for example oleate, ricinoleate, or stearate. The hydrophilic portion of the additives can contain at least two terminal hydroxyl groups derived from either: polyalkyene oxide chains totaling from about 5 to 60 moles of alkylene oxide, for example from 12 to 30 moles ethylene oxide; or condensed glycerol moiety of from 3 to 20 glycerol units, for example, from 3 to about 10 glycerol units; or one to four saccharide moieties, for example sucrose.

In an embodiment, appropriate regulatory bodies consider the additive to be suitable for inclusion in animal feed.

### Additional Components of the Additive

In an embodiment, the additive can include additional components. The additive may thus be formulated, diluted, stabilized, traced, preserved, or enhanced. Suitable components include alcohols or glycols; triglycerides; low HLB surfactants (co-surfactants); hydrophobic silica; or mineral oils or waxes. Suitable alcohols include ethanol and propylene glycol, and can be added in an amount of about 1% to about 30% of the weight of the additive. Suitable triglycerides include corn oil or corn distillers oil and can be added in an amount of about 1% to about 70% of the weight of the additive. Suitable co-surfactants include mono/di-glycerides and sorbitan esters with HLB less than about 7-8, and can be added in an amount of about 1% to about 15% of the weight of the additive. Suitable hydrophobic silicas include those sold under the trade names Cab-O-Sil TS 530 and Cab-O-Sil TS 720, which are available from Cabot Corporation, and can be added in an amount of about 0.5% to about 10% of the weight of the additive. Hydrophobic silica is well known as a thickening agent, demulsifier, and antifoam. Hydrophobic silica can be produced by derivatizing silica with reactive hydrophobic compounds, usually organosilanes. The silica can be produced by either precipitation from silicate solutions, or by combustion of silicon-containing compounds.

### Fermentation Processes Employing the Present Additive

The present method and additive can be employed with any of a variety of fermentation processes. For example, the method and additive can be employed in ethanol production from corn, either wet or dry grind processes. In addition, the present method and additive can be employed in fermentation of any of a variety of feedstocks, such as wheat, barley, sorghum, and other grains, beverage waste, waste sugar and starches, and other agricultural products, either alone or in combination with cellulosic materials. The product of such fermentation can be ethanol. Additional commercial products of fermentation include butanol, lactic acid, the Japanese food miso, and the like.

In an embodiment, the fermentation process includes or is ethanol production from, for example, corn. In such a process, mashing and fermentation converts the feed stock (e.g., corn) to a material referred to as beer. The beer can be distilled to separate the ethanol from (whole or thick) stillage. The whole stillage from a beer column can be centrifuged to produce wet cake and thin stillage. The thin stillage can then be subjected to evaporation (e.g., multiple effect evaporation) to increase the solids and recover the distillate for return use in the process. As solids increase the thin stillage can be referred to as syrup. The syrup can be combined with wet cake or distillers dry grains and sold as animal feed.

Such a process can include oil recovery as well. In oil recovery, the thin stillage or syrup can be, for example, centrifuged or extracted to remove oil (e.g., corn oil) from the syrup. In an embodiment, the process can include separating the oil from concentrated thin stillage (i.e., syrup) using a centrifuge, such as a disk stack centrifuge or a tricanter centrifuge. As thin stillage is concentrated to syrup, its volume decreases, allowing the use of smaller centrifuges. This can be balanced against the accompanying viscosity increase, which makes it harder to separate the oil. In an embodiment, the concentrated thin stillage can be heated before oil separation. The pH of the fermentation fluid may be adjusted in the separation process.

The present method can include adding the additive to the process stream at any of a variety of points in the separation process. In an embodiment, the present method includes adding the additive to the fermentation fluid at a point before the oil separation centrifuge. An embodiment of the present method includes adding the additive to beer before distillation or other separation. An embodiment of the present method includes adding the additive to whole stillage before to separation into thin stillage and wet cake. An embodiment of the present method includes adding the additive to thin stillage after the solid separation centrifuge. An embodiment of the present method includes adding the additive at a point in the evaporation unit operation, whether directly to the evaporator system, or to the process stream removed from the evaporator system. An embodiment of the present method includes adding the additive at a point after one or more evaporators but before the oil separation centrifuge. This can include adding to a premix tank, a retention or heating tank, a syrup feed tank, and associated pipes and pumps. An embodiment of the present method includes adding the additive to the syrup just before the oil separation centrifuge. The present method can also include adding the additive at a plurality of these points, positions, or apparatus, or to a plurality of different portions of the process stream.

In an embodiment, the present method includes adding the additive to whole stillage before removal of wet cake; to thin stillage at an inlet of an evaporator; to thin stillage at an outlet of an evaporator; to thin stillage in an evaporator; to the process stream at an inlet to a pre-mix heat tank; to the process stream at the retention heat tank; to syrup before the oil separation centrifuge; or a combination thereof.

The additive can be added under conditions of pH and temperature found in fermentation processes. For example, syrup resulting from concentration of thin stillage can be at about 60 to about 100° C. and pH of about 3 to about 6 and moisture content of about 15 to about 90 wt-% when it enters a centrifuge for separation of oil. In an embodiment, the additive can be heated and applied to the process stream (e.g., whole stillage, thin stillage, or syrup) at a temperature of about 20 to about 100° C., about 25 to about 85° C., or about 20 to about 80° C.

In an embodiment, the method includes adding the additive to thin stillage and/or to syrup concentrate before oil separation. Separating oil from the concentrated syrup can be achieved by a mechanical operation such as a membrane or centrifuge; for example, a centrifuge such as a disk stack or horizontal tricanter centrifuge.

The present invention may be better understood with reference to the following examples. These examples are intended to be representative of specific embodiments of the invention, and are not intended as limiting the scope of the invention.

### Examples

Samples of partially evaporated thin stillage were obtained from Midwestern dry grind corn-to-ethanol production plants. Aliquots were weighed out and heated to 65-85° C. A sample of additive was weighed out onto a plastic stirring rod, which allowed adding and mixing at the same time. Portions of 12-13 mL of the treated samples were transferred to a laboratory centrifuge tube and centrifuged at 3500 rpm. Experiments showed that the time between mixing and centrifugation, in the range of 2 minutes to 60 minutes, had no significant effect on the amount of oil recovered. Length of centrifugation was generally 30 seconds. Centrifuging for longer times, one minute up to five minutes, only increased the amount of oil recovered by a small amount.

Results were visually evaluated on a 0-5 scale, recognizing that it is often difficult to distinguish between adjacent rankings.

### Results

| Rank | Appearance |
|---|---|
| 0 | No visible oil phase, though an orange rag layer is often present |
| 1 | Small amount of oil, equivalent to 1-2 drops |
| 2 | Distinct oil layer, up to 1 mm thick |
| 3 | Oil layer up to 2-3 mm |
| 4 | Approximately ½ to ¾ ml oil |
| 5 | Approximately 1 mL oil |

### Surfactants and Related Products

The results shown in Table 1 shows the general lack of effectiveness of numerous commercially available surfactants. Despite similar overall molecular structure, HLB and cloud points, performance was poor for most surfactants tested. Antifoams, coagulant polymers, inorganic coagulants, and many other materials also failed. The few that work are seen to have a branched structure in the hydrophilic portion, resulting in the presence of at least two terminal hydroxyl groups.

Four additives, all nonionic surfactants, produced useful amounts of oil. These were surfactants sold under the trade names Aldosperse MS-20, Stepantex CO-40, PolyAldo 10-1-O, and Alkest 400 RH. Aldosperse ms-20 is a Ethoxylated Monoglyceride, specifically, a POE 20 glyceryl monostearate or a PEG 20 glyceryl stearate. It is a glyceryl monostearate that was ethoxylated with 20 moles of ethylene oxide. Stepantex CO-40 is an ethoxylated castor oil. It was ethoxylated with about 40 moles of ethylene oxide. Alkest 400 RH is an ethoxylated hydrogenated castor oil. It was also ethoxylated with about 40 moles of ethylene oxide. Polyaldo 10-1-O is a decaglyceryl monooleate. It consists of about ten glycerol molecules condensed and esterified with one oleic acid molecule.

TABLE 1
Oil Recovery Obtained with Various Additives

| | | | Cloud | | |
|---|---|---|---|---|---|
| Additive | Type | HLB | Point | ppm | Result |
| Blank | — | — | — | 0 | 1 |
| Blank | DI water | — | — | 19000 | 1 |
| Peg 400 MO | EO Monooleate | 11 | <20 | 427 | 1 |
| Peg 400 MO | EO Monooleate | 11 | <20 | 1360 | 1.5 |
| IGEPAL CO-730 ™ | Nonylphenol EO | 15 | 83 | 600 | 1 |
| MAKON TD-18 ™ | C13 EO | 16 | >85 | 588 | 1 |
| TOMADOL 25-9 ™ | EO alcohol | 13 | 60 | 632 | 0.5 |
| TOMADOL 91-8 ™ | EO alcohol | 14 | 63 | 633 | 0.5 |
| TRITON X-100 ™ | Octylphenol EO | 13 | 51 | 555 | 1 |
| CTAB | Quat | n/a | unk. | 376 | 1 |
| FeCl3 | Inorganic | — | — | 27 | 1 |
| PAC | Poly Aluminum | — | — | 40 | 1 |
| | Chloride | | | | |
| Tannin | Tannin | — | — | 829 | 1 |
| Propylene Glycol | Glycol | — | — | 1057 | 0.5 |
| FLOQUAT FL 2949 ™ | Cationic polymer | n/a | n/a | 180 | 1 |
| VOP | Vegetable Oil | unk. | unk. | 600 | 1 |
| | Phospholipids | | | | |
| ANTIFOAM B ™ | Silicone | unk. | <20 | 65 | 0.5 |
| MACKAM 810 AB ™ | Betaine | unk. | n/d | 1024 | 1 |
| JEFFAMINE 403 ™ | Polyamine | unk. | n/d | 604 | 1.5 |
| TOMAMINE | Amine | unk. | n/d | 706 | 1 |
| ALKALI ™ | | | | | |
| SXS 40 ™ | Sulfonate | unk. | n/d | 538 | 1 |
| DETERIC ODP-LF ™ | Octyl | unk. | n/d | 220 | 0.5 |
| | Dipropionate | | | | |
| PS 80 | Polysorbate | 15 | 58 | 209 | 1 |
| PS 80 | Polysorbate | 15 | 58 | 621 | 2.5 |
| ALDOSPERSE | EO | 13 | 48 | 571 | 2.5 |
| MS 20 ™ | Monoglyceride | | | | |
| POLYALDO | Polyglycerol | 13 | n/d | 438 | 2 |
| 10-1-O ™ | Monooleate | | | | |
| STEPANTEX | EO Castor Oil | 13 | n/d | 767 | 2.5 |
| CO-40 ™ | | | | | |
| OXITENO ALKEST | EO Hydrogenated | 13 | 70 | 150 | 2 |
| 400 RH ™ | Castor Oil | | | | |

### Hydrophobic Silica

The results shown in Table 2 illustrate the general lack of effectiveness of hydrophobic silica suspended in a variety of liquids, including surfactants. Only when mixed with a surfactant with the capability of enhancing oil recovery does the silica produce any improvement. The combination of multihydroxylic surfactant with hydrophobic silica produces better results than either alone.

TABLE 2
Oil Recovery Obtained with Various
Additives and Hydrophobic Silica

| Additive w/ SiO2 | ppm additive | ppm SiO₂ | Result |
|---|---|---|---|
| Acetone | 204 | 204 | 0.5 |
| CELLOSOLVE EB ™ | 526 | 34 | 1 |
| Corn Oil | 537 | 34 | 1 |
| Corn Oil | 829 | 53 | 1.5 |
| IGEPAL CO-730 ™ | 282 | 31 | 1.5 |
| IMUL PGE 32 ™ | 567 | 34 | 1 |
| Octanol | 656 | 42 | 1 |
| PEG 400 MO | 645 | 41 | 1 |
| Propylene Glycol | 595 | 38 | 1 |
| Tomadol blend* | 301 | 32 | 1.5 |
| Tomadol blend* | 513 | 54 | 1.5 |
| TRITON X-100 ™ | 304 | 35 | 1.5 |
| ALDOSPERSE MS-20 ™ | 580 | 35 | 3 |
| STEPANTEX CO-40 ™ | 494 | 30 | 4 |
| Stepantex CO-40 ™ plus | 467 | 25 | 1.5 |
| Aerosil A200 (hydrophilic | | | |
| silica) | | | |
| PS-80 | 420 | 44 | 4.5 |
| SISTERNA PS750 ™ | 500 | 25 | 2.5 |
| Sucrose Ester | | | |
| GILCO PANODAN | 910 | 23 | 1 |
| TARTRATE ™ | | | |
| STEPAN S LL ™ | 950 | 25 | 0.5 |
| STEPANTEX CO-30 ™ | 270 | 13 | 3 |

*30% Tomadol 600, 60% Tomadol 25-9, 10% SiO2

### Oil and Other Diluents

The presence of corn oil or other compatible liquids in the mixture reduces viscosity and in some cases improves oil recovery by amounts far in excess of the amount of oil added.

TABLE 3
Oil recovery with EO Castor Oil diluted with other liquids

| | ppm | ppm | |
|---|---|---|---|
| Additive w/ SiO2 | additive** | SiO₂ | Result |
| STEPANTEX CO-40 ™ in 50% corn oil | 279 | 33 | 4.5 |
| STEPANTEX CO-40 ™ in 60% water | 528 | 31 | 2.5 |
| STEPANTEX CO-40 ™ in 90% butyl | 109 | 445.5 | 4.5 |
| cellosolve | | | |

**actives, excluding diluent

### Field Test

A trial was conducted at a Midwestern fuel ethanol plant using a Tricanter oil separation system. An embodiment of the present additive including 3% propylene glycol, 3.5% hydrophobic silica, 8% sorbitan monolaurate, 20% corn distillers oil, and the balance ethoxylated castor oil was added to concentrated thin stillage to achieve a concentration of additive of 283 ppm. Oil production was 7.1 gallons per minute, compared with 5 gallons per minute without the additive.

### CONCLUSION

Many surfactants of similar HLB and cloud point were not effective on their own. Even when blended with hydrophobic silica, they are generally ineffective. In particular, alkoxylated fatty alcohols, alkoxylated fatty acids, sulfonated alkoxylates, alkyl quaternary ammonium compounds, alkyl amine compounds, alkyl phenol ethoxylates and low molecular weight silicones were found ineffective. The few that worked have a branched structure in the hydrophilic portion, which resulted in the presence of at least two terminal hydroxyl groups. The combination of multihydroxylic surfactant with hydrophobic silica produced better results than either alone.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

We claim:

1. A method for recovering oil from a fermentation process, comprising:
adding an additive to a process stream, wherein the additive comprises ethoxylated glyceryl monostearate, ethoxylated castor oil, ethoxylated hydrogenated castor oil, polyglyceryl monooleate, a sucrose ester of a fatty acid, or a mixture thereof.

2. The method of claim 1, wherein the ethoxylated glyceryl monostearate comprises about 20 ethoxylate moieties.

3. The method of claim 1, wherein the ethoxylated glyceryl monostearate comprises PEG20 glyceryl stearate.

4. The method of claim 1, wherein the ethoxylated castor oil or ethoxylated hydrogenated castor oil comprises about 40 ethoxylate moieties.

5. The method of claim 1, wherein the polyglyceryl monooleate comprises about 10 condensed glycerol molecules.

6. The method of claim 1, wherein the sucrose ester comprises sucrose monopalmitate.

7. The method of claim 1, wherein the process stream comprises whole stillage, thin stillage, concentrated thin stillage, syrup, or a plurality thereof.

8. A method for recovering oil from a fermentation process, comprising:
adding an additive to a process stream wherein the additive comprises a functionalized multihydroxyl moiety comprising a hydrophobic portion;
the functionalized multihydroxyl moiety being derived from glycerol, polyglycerol, glucose, sucrose, citric acid, lactic acid, tartaric acid, or an amino acid; and
the hydrophobic portion comprising one or two alkyl groups of 6 to 24 carbons each.

9. The method of claim 8, wherein the additive comprises an alkylated polyglycerol, an alkoxylated castor oil, an alkoxylated hydrogenated castor oil, an alkoxylated monoglyceride, an alkoxylated mono/di-glyceride, an oligosaccharide ester, or a mixture thereof.

10. The method of claim 9, wherein the alkylated polyglycerol comprises a polyglycerol containing 3-20 glycerol units acylated or alkylated with one or two alkyl groups of 6 to 24 carbons.

11. The method of claim 9, wherein the alkoxylated castor oil or alkoxylated hydrogenated castor oil is alkoxylated with from 10 to 60 moles of alkyl oxide.

12. The method of claim 9, wherein the alkoxylated monoglyceride or alkoxylated mono/di-glyceride comprises about 5 to about 40 alkoxylate moieties and one or two alkyl groups of 6 to 24 carbons.

13. The method of claim 9, wherein the oligosaccharide ester comprises one to four saccharide moieties acylated or alkylated with one or two alkyl groups of 6 to 24 carbons.

14. The method of claim 8, wherein the functionalized multihydroxyl moiety is derived from a monoglyceride, a mono/di-glyceride, a polyglycerol, a saccharide, castor oil, or hydrogenated castor oil.

15. The method of claim 8, wherein the functionalized multihydroxyl moiety is derived from ethoxylated monoglyceride, ethoxylated diglyceride, polyglycerol ester, or ethoxylated castor oil.

16. The method of claim 8, wherein the functionalized multihydroxyl moiety comprises ethoxylated monoglyceride or ethoxylated mono/di-glyceride with one or two alkyl or acyl groups of 6 to 24 carbons each, alkoxylated with from 5 to 40 moles of alkylene oxide or alkylene glycol.

17. The method of claim 8, wherein the functionalized multihydroxyl moiety has been alkylated or acylated to form a monolaurate, monooleate, monopalmitate or monostearate, and has been alkoxylated with from about 12 to about 25 moles of an alkoxylate wherein the alkoxylate is selected from ethylene oxide, propylene oxide or mixtures thereof.

18. A method for recovering oil from a fermentation process, comprising:
adding an additive to a process stream wherein the additive comprises a functionalized multihydroxyl moiety comprising a hydrophilic portion and a hydrophobic portion;
the hydrophilic portion comprising at least two terminal hydroxyl groups; and
the hydrophobic portion comprising one or two alkyl groups of 6 to 24 carbons each;
wherein the functionalized polyol is not derived from sorbitol, sorbitan, or an isosorbide.

19. The method of claim 1, wherein the fermentation process comprises ethanol production from corn.

20. The method of claim 1, comprising adding the additive to a concentration of about 50 to about 1000 ppm based on the weight of the process stream.

21. The method of claim 1, comprising adding additive:
to beer before distillation;
to whole stillage before removal of wet cake;
to thin stillage;
to concentrated thin stillage;
to the process stream before an oil separation centrifuge;
a combination thereof.

22. The method of claim 1, wherein the additive further comprises up to 15% by weight hydrophobic silica.

23. The method of claim 22, wherein the additive further comprises a vegetable oil containing at least 6% free fatty acids.

24. The method of claim 8, wherein the fermentation process comprises ethanol production from corn.

25. The method of claim 8, comprising adding the additive to a concentration of about 50 to about 1000 ppm based on the weight of the process stream.

26. The method of claim 8, comprising adding additive:
to beer before distillation;
to whole stillage before removal of wet cake;
to thin stillage;
to concentrated thin stillage;
to the process stream before an oil separation centrifuge;
a combination thereof.

27. The method of claim 8, wherein the additive further comprises up to 15% by weight hydrophobic silica.

28. The method of claim 27, wherein the additive further comprises a vegetable oil containing at least 6% free fatty acids.
